(19) United States
(12) Patent Application Publication
(10) Pub. No.: US 2018/0132129 A1
(43) Pub. Date: May 10, 2018

(54) APPARATUSES AND METHODS FOR PACKET FILTER MANAGEMENT

(71) Applicant: MediaTek Singapore Pte. Ltd., Singapore (SG)

(72) Inventors: Jaakko SITOMANIEMI, Oulu (FI); Marko NIEMI, Oulu (FI)

(21) Appl. No.: 15/346,945

(22) Filed: Nov. 9, 2016

(51) Int. Cl. H04W 28/02; H04W 72/08; H04L 12/859

(52) U.S. Cl. CPC H04W 28/0263; H04L 47/2475; H04W 28/0226; H04W 72/087

(57) ABSTRACT

A mobile communication device including a wireless transceiver and a controller is provided. The wireless transceiver performs wireless transmission and reception to and from a service network. The controller receives a rejection message from the service network via the wireless transceiver in response to initiating a bearer resource modification procedure for releasing a part of a plurality of packet filters, and in response to the rejection message, locally releases the part of the packet filters and performs a tracking area update procedure to synchronize current packet filter status and Quality of Service (QoS) requirement with the service network, or re-initiates the bearer resource modification procedure when a predetermined period of time since the reception of the rejection message has elapsed.

### BACKGROUND OF THE APPLICATION

### Field of the Application

The application generally relates to packet filter management, and more particularly, to packet filter management for failures of User Equipment (UE)-requested bearer resource modification procedure.

### Description of the Related Art

With growing demand for ubiquitous computing and networking, various wireless technologies have been developed, including the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) 1× technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced (LTE-A) technology, etc.

A UE may have more than one application running and correspondingly, the UE may have two or more Traffic Flow Aggregates (TFAs) including packet filters for those traffic flows allocated in one Evolved Packet System (EPS) bearer. If one of the applications is stopped in the UE, the UE may need to release resources and clean-up the traffic flow associated with the stopped application by initiating the bearer resource modification procedure. The bearer resource modification procedure may serve as a trigger for the network side to release resources that are no longer needed at both the UE side and network side.

Due to a number of potential reasons, such as an unspecified network problem or a weak signal coverage, the attempt to release resources via peer-to-peer signalling may fail. Take the LTE technology as an example: according to the 3rd Generation Partnership Project (3GPP) Technical Specification (TS) 24.301, the UE simply enters the PROCEDURE TRANSACTION INACTIVE state when the bearer resource modification procedure for releasing partial resources fails due to an unspecified network problem or a weak signal coverage. In other words, in cases of failure for partial release, the UE will keep all packet filters including the one(s) that is/are no longer needed. As a result, the network side does not know that certain traffic flow associated with the stopped application has stopped and may mistakenly use the traffic flow and associated packet filter.

Thus, it is desirable to improve packet filter management for failures of UE-requested bearer resource modification procedure.

### BRIEF SUMMARY OF THE APPLICATION

In a first aspect of the application, a mobile communication device comprising a wireless transceiver and a controller is provided. The wireless transceiver is configured to perform wireless transmission and reception to and from a service network. The controller is configured to receive a rejection message from the service network via the wireless transceiver in response to initiating a bearer resource modification procedure for releasing a part of a plurality of packet filters, and in response to the rejection message, locally release the part of the packet filters and perform a tracking area update procedure to synchronize current packet filter status and Quality of Service (QoS) requirement with the service network, or re-initiate the bearer resource modification procedure when a predetermined period of time since the reception of the rejection message has elapsed.

In a second aspect of the application, a method for packet filter management, executed by a mobile communication device, is provided. The method comprises the steps of: receiving a rejection message from a service network in response to initiating a bearer resource modification procedure for releasing a part of a plurality of packet filters; and in response to the rejection message, locally releasing the part of the packet filters and performing a tracking area update procedure to synchronize current packet filter status and QoS requirement with the service network, or re-initiating the bearer resource modification procedure when a predetermined period of time since the reception of the rejection message has elapsed.

In a third aspect of the application, a mobile communication device comprising a wireless transceiver and a controller is provided. The wireless transceiver is configured to perform wireless transmission and reception to and from a service network. The controller is configured to initiate a bearer resource modification procedure with the service network via the wireless transceiver for releasing a part of a plurality of packet filters, and in response to re-initiating the bearer resource modification procedure for a predetermined number of times and not receiving any response message from the service network, locally release the part of the packet filters and perform a tracking area update procedure to synchronize current packet filter status and QoS requirement with the service network when detecting the mobile communication device in a service area of the service network, or re-initiate the bearer resource modification procedure when detecting the mobile communication device in the service area of the service network.

In a fourth aspect of the application, a method for packet filter management, executed by a mobile communication device, is provided. The method comprises the steps of: initiating a bearer resource modification procedure with a service network for releasing a part of a plurality of packet filters; and in response to re-initiating the bearer resource modification procedure for a predetermined number of times and not receiving any response message from the service network, locally releasing the part of the packet filters and performing a tracking area update procedure to synchronize current packet filter status and QoS requirement with the service network when detecting the mobile communication device in a service area of the service network, or re-initiating the bearer resource modification procedure when detecting the mobile communication device in the service area of the service network.

Other aspects and features of the present application will become apparent to those with ordinarily skill in the art upon review of the following descriptions of specific embodiments of the mobile communication devices and the methods for packet filter management.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the mobile communication device 110 according to an embodiment of the application;

FIG. 3 is a message sequence chart illustrating packet filter management for a UE-requested bearer resource modification procedure being rejected by network according to an embodiment of the application;

FIG. 4 is a message sequence chart illustrating packet filter management for a UE-requested bearer resource modification procedure being rejected by network according to another embodiment of the application;

FIGS. 5A and 5B show a message sequence chart illustrating packet filter management for failures of a UE-requested bearer resource modification procedure due to a weak signal coverage according to an embodiment of the application; and

FIGS. 6A and 6B show a message sequence chart illustrating packet filter management for failures of a UE-requested bearer resource modification procedure due to a weak signal coverage according to another embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The 3GPP specifications are used to teach the spirit of the application, and the application is not limited thereto.

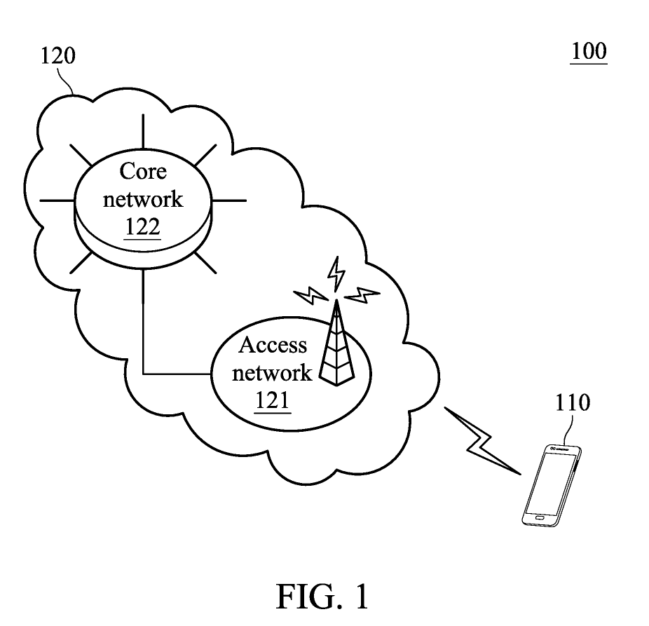

FIG. 1 is a block diagram of a wireless communication environment according to an embodiment of the application. The wireless communication environment 100 comprises a mobile communication device 110 and a service network 120, wherein the mobile communication device 110 is wirelessly connected to the service network 120 for obtaining mobile services. The mobile communication device 110 may be referred to as User Equipment (UE), such as a feature phone, a smartphone, a panel Personal Computer (PC), a laptop computer, or any computing device supporting the wireless technology utilized by the service network 120. The service network 120 may be an LTE/LTE-A/TD-LTE network.

Specifically, the service network 120 comprises an access network 121 and a core network 122, wherein the access network 121 is responsible for processing radio signals, terminating radio protocols, and connecting the mobile communication device 110 with the core network 122, while the core network 122 is responsible for performing mobility management, network-side authentication, and interfaces with public/external networks (e.g., the Internet). Each of the access network 121 and the core network 122 may comprise one or more network nodes for carrying out said functions. For example, the access network 121 may be an Evolved-UTRAN (E-UTRAN) which includes at least an evolved NB (eNB) (e.g., a macro eNB, femto eNB, or pico eNB), and the core network 122 may be an Evolved Packet Core (EPC) which includes a Home Subscriber Server (HSS), Mobility Management Entity (MME), Serving Gateway (S-GW), and Packet Data Network Gateway (PDN-GW or P-GW).

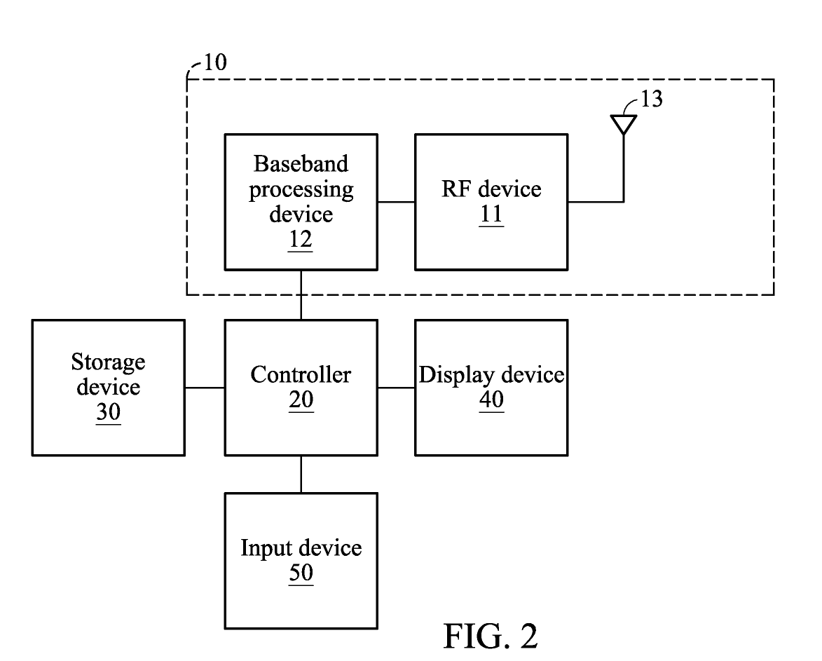

FIG. 2 is a block diagram illustrating the mobile communication device 110 according to an embodiment of the application. The mobile communication device 110 comprises a wireless transceiver 10, a controller 20, a storage device 30, a display device 40, and an input device 50. The wireless transceiver 10 is configured to perform wireless transmission and reception to and from the service network 120. The wireless transceiver 10 comprises a Radio Frequency (RF) device 11, a baseband processing device 12, and an antenna 13. The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device 11 may receive RF wireless signals via the antenna 13, convert the received RF wireless signals to baseband signals, which are processed by the baseband processing device 12, or receive baseband signals from the baseband processing device 12 and convert the received baseband signals to RF wireless signals, which are later transmitted via the antenna 13. The RF device 11 may also contain multiple hardware devices to perform radio frequency conversion. For example, the RF device 11 may comprise a mixer to multiply the baseband signals with a carrier oscillated in the radio frequency of the supported wireless technologies, wherein the radio frequency may be 900 MHz, 2100 MHz, or 2.6 GHz utilized in LTE/LTE-A/TD-LTE technology, or another radio frequency, depending on the wireless technology in use.

The controller 20 may be a general-purpose processor, a Micro Control Unit (MCU), an application processor, a Digital Signal Processor (DSP), or the like, which includes various circuitry for providing the function of data processing and computing, controlling the wireless transceiver 10 for wireless communications with the service network 120, storing and retrieving data to and from the storage device 30, sending a series of frame data (e.g. representing text messages, graphics, images, etc.) to the display device 40, and receiving signals from the input device 50. In particular, the controller 20 coordinates the aforementioned operations of the wireless transceiver 10, the storage device 30, the display device 40, and the input device 50 for performing the method of the present application.

In another embodiment, the controller 20 may be incorporated into the baseband processing device 12, serving as a baseband processor.

As will be appreciated by persons skilled in the art, the circuitry of the controller 20 will typically include transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing instructions and/or program code of applications, communication protocols, and/or the method of the present application.

The display device 40 may be a Liquid-Crystal Display (LCD), Light-Emitting Diode (LED) display, or Electronic Paper Display (EPD), etc., for providing a display function. Alternatively, the display device 30 may further comprise one or more touch sensors disposed thereon or thereunder for sensing touches, contacts, or approximations of objects, such as fingers or styluses.

The input device 50 may comprise one or more buttons, a keyboard, a mouse, a touch pad, a video camera, a microphone, and/or a speaker, etc., serving as the Man-Machine Interface (MIMI) for interaction with users.

It should be understood that the components described in the embodiment of FIG. 2 are for illustrative purposes only and are not intended to limit the scope of the application.

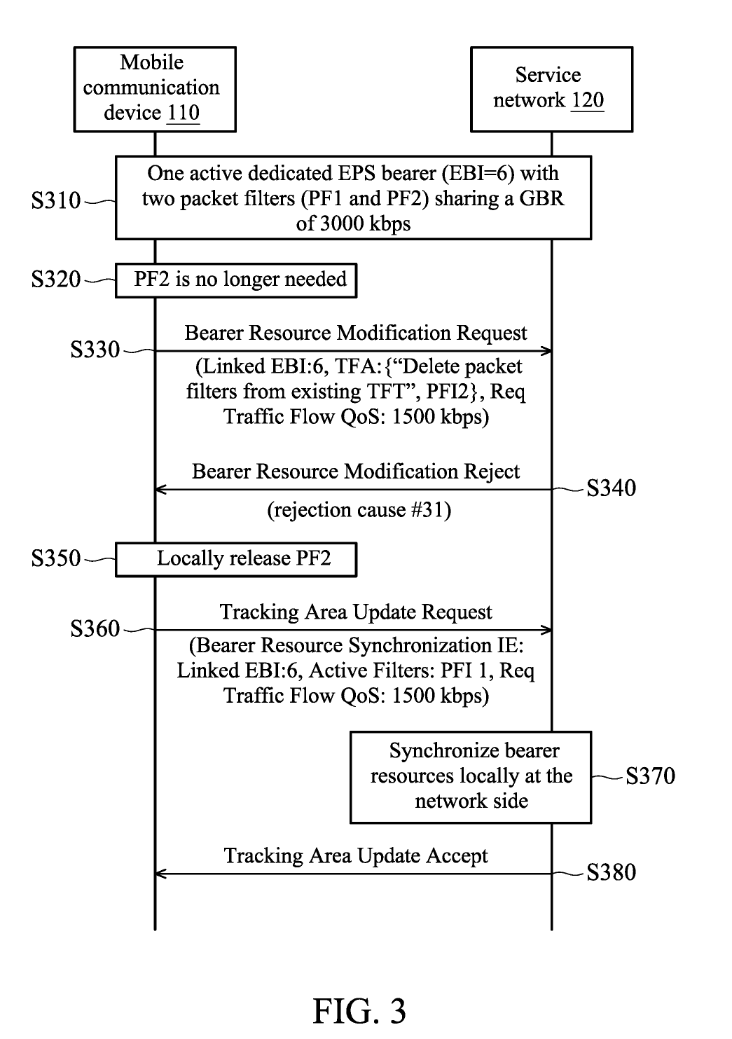

FIG. 3 is a message sequence chart illustrating packet filter management for a UE-requested bearer resource modification procedure being rejected by network according to an embodiment of the application. To begin, the mobile communication device 110 has established an active dedicated EPS bearer with the service network 120, wherein the EPS Bearer Identity (EBI) of the EPS bearer is 6, the EPS bearer has two UE-allocated packet filters (denoted as PF1 and PF2), and the EPS bearer is a Guaranteed Bit Rate (GBR) bearer with a shared bitrate of 3000 kbps in which the traffic flow of PF1 requires only 1500 kbps (step S310).

Next, the mobile communication device 110 determines that PF2 is no longer needed (step S320). For example, PF2 may be determined to be no longer needed when the application associated with the traffic flow of PF2 has stopped. When determining that PF2 is no longer needed, the mobile communication device initiates the bearer resource modification procedure for releasing PF2. Specifically, the mobile communication device 110 sends a Bearer Resource Modification Request message to the service network 120, wherein the Bearer Resource Modification Request message includes the information of PF2 and the QoS requirement after the modification (step S330).

Subsequently, the mobile communication device 110 receives a Bearer Resource Modification Reject message from the service network 120, wherein the Bearer Resource Modification Reject message includes a rejection cause #31 which indicates “request rejected, unspecified” (step S340). In another embodiment, the Bearer Resource Modification Reject message may include a rejection cause #26 which indicates “insufficient resources”, and the application is not limited thereto. In response to the Bearer Resource Modification Reject message including a rejection cause #31, the mobile communication device 110 locally releases PF2 (step S350), and then performs the tracking area update procedure to synchronize the current packet filter status and QoS requirement with the service network 120, by sending a Tracking Area Update Request message to the service network 120 (step S360).

In one embodiment, the Tracking Area Update Request message includes a newly defined Information Element (IE) which contains the Traffic Flow Template (TFT) information (e.g., active packet filter ID(s)) for each active EPS bearer and corresponding QoS requirement. In another embodiment, the Tracking Area Update Request message includes the EPS bearer context status IE which is enhanced with the TFT information (e.g., active packet filter ID(s)) for each active EPS bearer and corresponding QoS requirement for all active EPS bearers. In yet another embodiment, the Tracking Area Update Request message includes the EPS bearer context status IE which is enhanced with the TFT information (e.g., active packet filter ID(s)) and corresponding QoS requirement for only the EPS bearer that has been modified.

As shown in FIG. 3, due to the fact that there is only one active EPS bearer and only one active packet filter remained after the local release of PF2, the Tracking Area Update Request message includes information of EBI 6, PF Identify (PFI) 1, and QoS requirement of 1500 kbps.

When receiving the Tracking Area Update Request message, the service network 120 synchronizes the bearer resources locally at the network side (step S370), and replies to the mobile communication device 110 with a Tracking Area Update Accept message (step S380), and the method ends.

In another embodiment, if the service network 120 would like to further modify the bearer resources, it may include the information of requested packet filter status and QoS requirement in the Tracking Area Update Accept message for the mobile communication device 110 to synchronize the bearer resources at the UE side, and the mobile communication device 110 may further reply to the service network with a Tracking Area Update Complete message to confirm the synchronization.

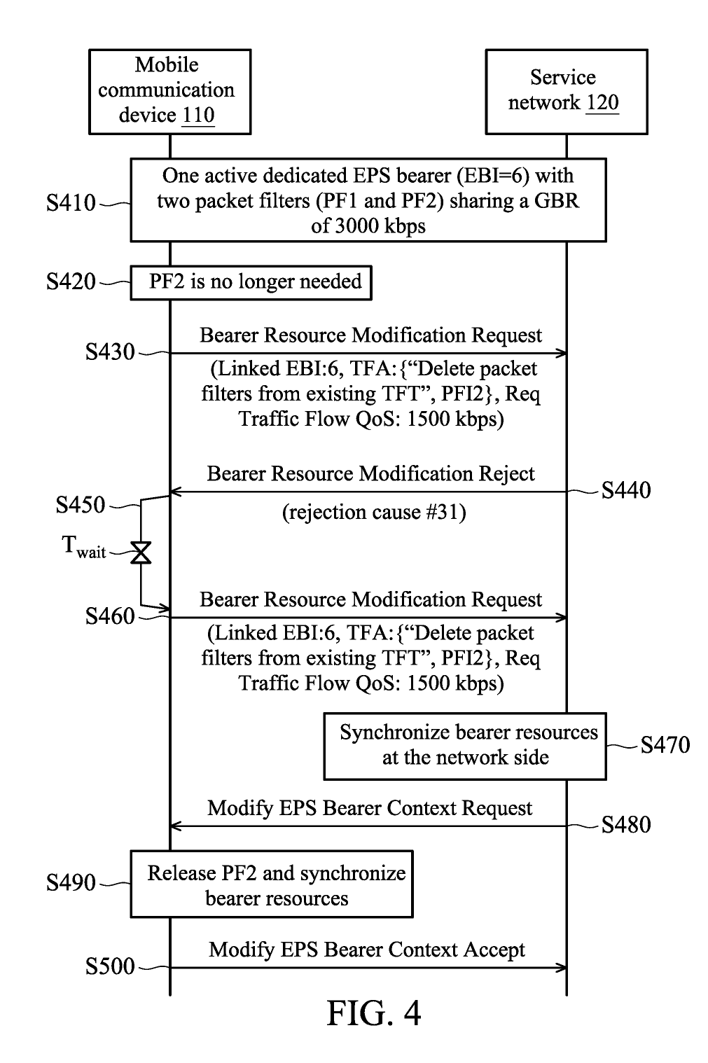

FIG. 4 is a message sequence chart illustrating packet filter management for a UE-requested bearer resource modification procedure being rejected by network according to another embodiment of the application. In this embodiment, steps S410˜S440 are similar to steps S310˜S340 in FIG. 3, and thus, the detailed description of steps S410˜S440 is omitted herein for brevity.

Subsequent to step S440, the mobile communication device 110 starts a wait timer (denoted as T_{wait} in FIG. 4) to count a predetermined period of time when receiving the Bearer Resource Modification Reject message with a rejection cause #31 (step S450). Specifically, the wait timer may be a new timer set to count 30 seconds. In another embodiment, if the rejection cause in the Bearer Resource Modification Reject message is #26, the method of the application may also be applied with the wait timer being a back-off timer (e.g., T3396) having a duration specified in the Bearer Resource Modification Reject message by the network, and the mobile communication device 110 is refrained from re-initiating the EPS bearer context modification procedure when the back-off timer is running.

Next, when the wait timer expires, the mobile communication device 110 re-initiates the bearer resource modification procedure by sending a Bearer Resource Modification Request message including the information of PF2 and the QoS requirement after the modification to the service network 120 (step S460).

When receiving the Bearer Resource Modification Request message, the service network 120 synchronizes the bearer resources at the network side (step S470), and replies to the mobile communication device 110 with a Modify EPS Bearer Context Request message (step S480).

When receiving the Modify EPS Bearer Context Request message, the mobile communication device 110 releases PF2 and synchronizes the bearer resources (step S490), and replies to the service network 120 with a Modify EPS Bearer Context Accept message (step S500) to end the method process.

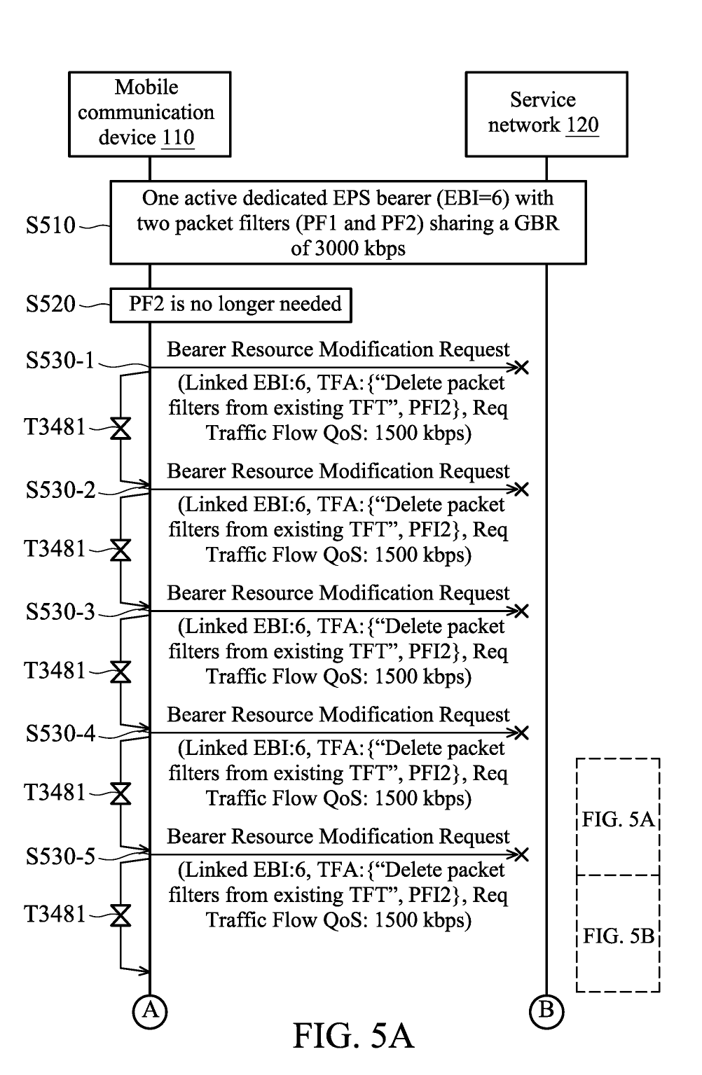

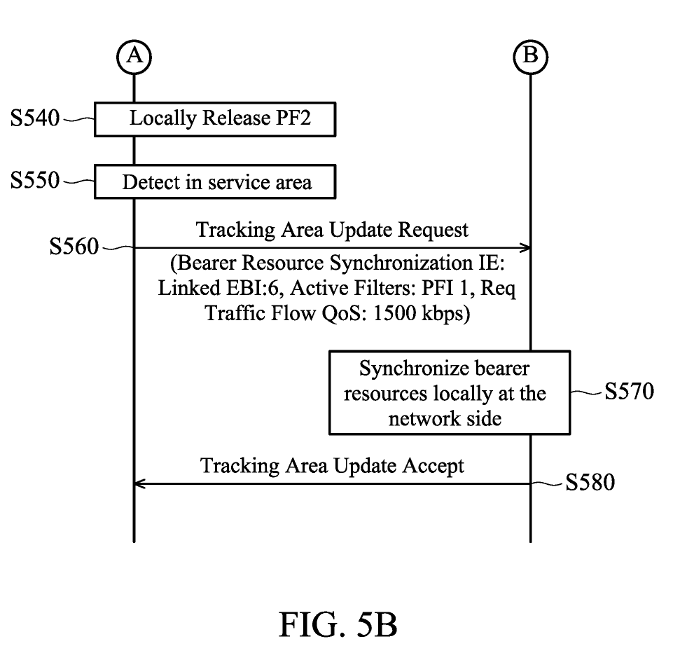

FIGS. 5A and 5B show a message sequence chart illustrating packet filter management for failures of a UE-requested bearer resource modification procedure due to a weak signal coverage according to an embodiment of the application. In this embodiment, steps S510 and S520 are similar to steps S310 and S320 in FIG. 3, and thus, the detailed description of steps S510 and S520 is omitted herein for brevity.

Subsequent to step S520, the mobile communication device 110 initiates the bearer resource modification procedure by sending a Bearer Resource Modification Request message including the information of PF2 and the QoS requirement after the modification to the service network 120 (step S530-1) and starting a guard timer T3481 upon sending the Bearer Resource Modification Request message. However, due to a weak signal coverage of the service network 120, message exchange between the mobile communication device 110 and the service network 120 is not possible, and thus, transmission of the Bearer Resource Modification Request message fails.

Next, the mobile communication device 110 resends the Bearer Resource Modification Request message each time the guard timer T3481 expires, until a maximum attempt count (e.g., 5) is reached (step S530-2˜S530-5).

In response to the fifth timeout of the guard timer T3481, the mobile communication device 110 locally releases PF2 (step S540). Later, when detecting that the mobile communication device 110 is in the service area of the service network 120 (i.e., in a fair signal coverage) of the service network 120 (step S550), the mobile communication device 110 performs the tracking area update procedure to synchronize the current packet filter status and QoS requirement with the service network 120, by sending a Tracking Area Update Request message to the service network 120 (step S560).

When receiving the Tracking Area Update Request message, the service network 120 synchronizes the bearer resources locally at the network side (step S570), and replies to the mobile communication device 110 with a Tracking Area Update Accept message (step S580), and the method ends.

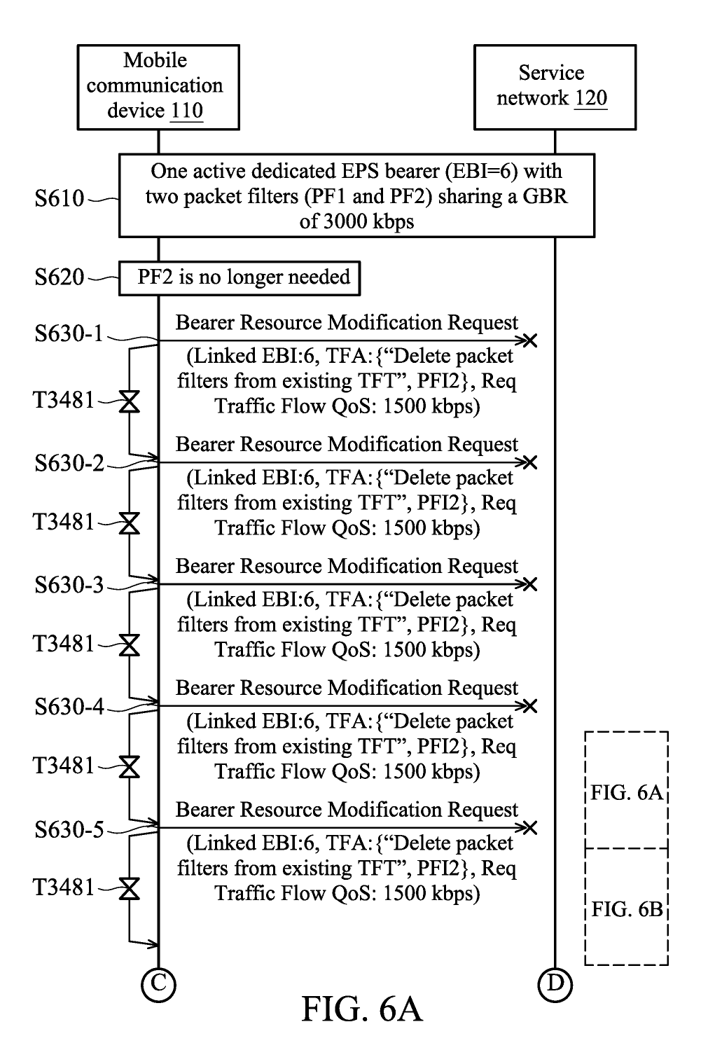

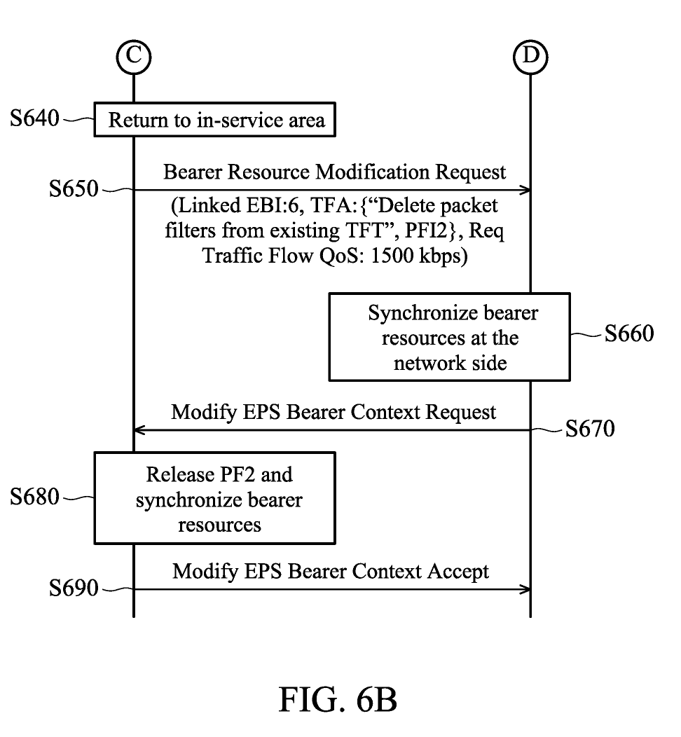

FIGS. 6A and 6B show a message sequence chart illustrating packet filter management for failures of a UE-requested bearer resource modification procedure due to a weak signal coverage according to another embodiment of the application. In this embodiment, steps S610˜S630-5 are similar to steps S510˜S530-5 in FIG. 5A, and thus, the detailed description of steps S610˜S630-5 is omitted herein for brevity.

Subsequent to step S630-5, the mobile communication device 110 waits until it has returned to the service area of the service network 120 (i.e., in a fair signal coverage) of the service network 120 (step S640), and then re-initiates the bearer resource modification procedure by sending a Bearer Resource Modification Request message including the information of PF2 and the QoS requirement after the modification to the service network 120 (step S650).

When receiving the Bearer Resource Modification Request message, the service network 120 synchronizes the bearer resources at the network side (step S660), and replies to the mobile communication device 110 with a Modify EPS Bearer Context Request message (step S670).

When receiving the Modify EPS Bearer Context Request message, the mobile communication device 110 releases PF2 and synchronizes the bearer resources (step S680), and replies to the service network 120 with a Modify EPS Bearer Context Accept message (step 5690) to end the method process.

Regarding the embodiments of FIGS. 3 and 5A-5B, an exemplary IE structure for containing the packet filter status and QoS requirement in the Tracking Area Update Request message is given below as a “Bearer Resource Synchronization” IE.

One EBC information element consists of a list of active packet filter IDs and associated EPS QoS requirements. An exemplary IE structure for an EBC information element is given below.
One packet filter ID is represented using 4 bits, so each octet in the packet filter ID list can define 2 packet filter IDs, as shown below.
An exemplary IE structure for the traffic flow QoS information is given below.
Please note that the length of QoS requirement is variable. For example, if an update of the QoS requirement is not necessary (e.g., for a non-GBR bearer), the length of QoS requirement may also be zero bytes.

In view of the forgoing embodiment of FIGS. 3, 4, 5A-5B, and 6A-6B, it will be appreciated that the present application improves packet filter management for failures of UE-requested bearer resource modification procedure, by allowing the UE to release packet filters locally and inform the service network to synchronize the current packet filter status and QoS requirement, or by allowing the UE to retry the bearer resource modification procedure as a trigger for the service network to release unused resources at both the UE side and network side. Advantageously, the misuse of traffic flow and associated packet filter may be avoided.

While the application has been described by way of example and in terms of preferred embodiment, it is to be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A mobile communication device, comprising:
a wireless transceiver, configured to perform wireless transmission and reception to and from a service network; and
a controller, configured to receive a rejection message from the service network via the wireless transceiver in response to initiating a bearer resource modification procedure for releasing a part of a plurality of packet filters, and in response to the rejection message, locally release the part of the packet filters and perform a tracking area update procedure to synchronize current packet filter status and Quality of Service (QoS) requirement with the service network, or re-initiate the bearer resource modification procedure when a predetermined period of time since the reception of the rejection message has elapsed.

2. The mobile communication device of claim 1, wherein the tracking area update procedure comprises sending a tracking area update request message to the service network via the wireless transceiver, and the tracking area update request message comprises Traffic Flow Template (TFT) information for each Evolved Packet System (EPS) bearer and corresponding QoS requirement for all active EPS bearers.

3. The mobile communication device of claim 1, wherein the tracking area update procedure comprises sending a tracking area update request message to the service network via the wireless transceiver, and the tracking area update request message comprises TFT information and corresponding QoS requirement for only the EPS bearer that has been modified.

4. The mobile communication device of claim 1, wherein the rejection message comprises a rejection cause indicating “request rejected, unspecified” or “insufficient resources”.

5. The mobile communication device of claim 4, wherein the predetermined period of time is a back-off duration specified by the rejection message when the rejection cause indicates “insufficient resources”.

6. A method for packet filter management, executed by a mobile communication device, the method comprising:
receiving a rejection message from a service network in response to initiating a bearer resource modification procedure for releasing a part of a plurality of packet filters; and
in response to the rejection message, locally releasing the part of the packet filters and performing a tracking area update procedure to synchronize current packet filter status and QoS requirement with the service network, or re-initiating the bearer resource modification procedure when a predetermined period of time since the reception of the rejection message has elapsed.

7. The method of claim 6, wherein the tracking area update procedure comprises sending a tracking area update request message to the service network, and the tracking area update request message comprises TFT information for each EPS bearer and corresponding QoS requirement for all active EPS bearers.

8. The method of claim 6, wherein the tracking area update procedure comprises sending a tracking area update request message to the service network, and the tracking area update request message comprises TFT information and corresponding QoS requirement for only the EPS bearer that has been modified.

9. The method of claim 6, wherein the rejection message comprises a rejection cause indicating “request rejected, unspecified” or “insufficient resources”.

10. The method of claim 9, wherein the predetermined period of time is a back-off duration specified by the rejection message when the rejection cause indicates “insufficient resources”.

11. A mobile communication device, comprising:
a wireless transceiver, configured to perform wireless transmission and reception to and from a service network; and
a controller, configured to initiate a bearer resource modification procedure with the service network via the wireless transceiver for releasing a part of a plurality of packet filters, and in response to re-initiating the bearer resource modification procedure for a predetermined number of times and not receiving any response message from the service network, locally release the part of the packet filters and perform a tracking area update procedure to synchronize current packet filter status and QoS requirement with the service network when detecting the mobile communication device in a service area of the service network, or re-initiate the bearer resource modification procedure when detecting the mobile communication device in the service area of the service network.

12. The mobile communication device of claim 11, wherein the tracking area update procedure comprises sending a tracking area update request message to the service network via the wireless transceiver, and the tracking area update request message comprises TFT information for each EPS bearer and corresponding QoS requirement for all active EPS bearers.

13. The mobile communication device of claim 11, wherein the tracking area update procedure comprises sending a tracking area update request message to the service network via the wireless transceiver, and the tracking area update request message comprises TFT information and corresponding QoS requirement for only the EPS bearer that has been modified.

14. A method for packet filter management, executed by a mobile communication device, the method comprising:
initiating a bearer resource modification procedure with a service network for releasing a part of a plurality of packet filters; and
in response to re-initiating the bearer resource modification procedure for a predetermined number of times and not receiving any response message from the service network, locally releasing the part of the packet filters and performing a tracking area update procedure to synchronize current packet filter status and QoS requirement with the service network when detecting the mobile communication device in a service area of the service network, or re-initiating the bearer resource modification procedure when detecting the mobile communication device in the service area of the service network.

15. The method of claim 14, wherein the tracking area update procedure comprises sending a tracking area update request message to the service network, and the tracking area update request message comprises TFT information for each EPS bearer and corresponding QoS requirement for all active EPS bearers.

16. The method of claim 14, wherein the tracking area update procedure comprises sending a tracking area update request message to the service network, and the tracking area update request message comprises TFT information and corresponding QoS requirement for only the EPS bearer that has been modified.
